(19) United States
(12) Patent Application Publication
(10) Pub. No.: US 2014/0181249 A1
(43) Pub. Date: Jun. 26, 2014

(54) STORAGE MEDIUM, INFORMATION PROCESSING APPARATUS, AND OBJECT TRANSMISSION METHOD

(71) Applicant: FUJITSU LIMITED, Kawasaki-shi (JP)

(72) Inventor: Toshiaki Saeki, Kawasaki (JP)

(73) Assignee: FUJITSU LIMITED, Kawasaki-shi (JP)

(21) Appl. No.: 14/058,760

(22) Filed: Oct. 21, 2013

(30) Foreign Application Priority Data
Dec. 20, 2012 (JP) 2012-277894

(51) Int. Cl. H04L 29/06

(52) U.S. Cl. CPC H04L 65/1069
USPC 709/217

(57) ABSTRACT

A non-transitory computer-readable storage medium storing a program causing a computer that communicates with another computer to execute a process, the process includes establishing connections corresponding to types of object with the other computer, each type of object including two or more data items; selecting, from the connections, a first connection corresponding to a type of an object to be transmitted; and transmitting the object to the other computer through the first connection.

### CROSS-REFERENCE TO RELATED APPLICATION

This application is based upon and claims the benefit of priority of the prior Japanese Patent Application No. 2012-277894, filed on Dec. 20, 2012, the entire contents of which are incorporated herein by reference.

### FIELD

The embodiments discussed herein are related to a storage medium, an information processing apparatus, and an object transmission method.

### BACKGROUND

Today, object-oriented languages are often used as programming languages to develop software. In object-oriented languages, types of object including fields and methods are defined. Types of object may also be called “classes”. Fields may also be called “attributes” or “member variables”. Methods may also be called “member functions”. When a program written in an object-oriented language is executed, specific data are assigned to fields based on the type of object, so that an object is generated. Data in the fields included in the object are arranged in a memory in a computer in accordance with the structure of the object. Data in fields included in one object may or may not be stored in a contiguous storage area in the memory.

Object-oriented languages as described above may also be used to develop software that runs on a distributed processing system in which a plurality of computers communicate with each other over a network. When a program written in an object-oriented language is executed by a plurality of computers, an object may be transmitted from one computer to another.

Typically, at a transmitting end, middleware, such as a library or framework, converts (serializes) an object into a message in a format transmittable over a network. For example, data in fields are arranged in an order according to a predetermined rule. The serialized message is then output to the network via an operating system (OS) and a communication interface. A receiving end obtains the serialized message via a communication interface and an OS. Middleware, such as a library or framework, extracts the data in the fields from the message and reconstructs (deserializes) the object in a memory.

There is a proposed system in which, in order to transmit a message from one node to another node, reception buffers are provided in a main storage device in a node at a receiving end and a network adapter in the node at the receiving end writes the message to any of the reception buffers in the main storage device without using an OS. In the proposed system, the reception buffers are selected based on a header of the message.

For example, Japanese Laid-open Patent Publication No. 9-167143 is disclosed as related art.

With a method in which an object is transmitted between computers, the computer at a receiving end executes processing for analyzing a message by software, extracting data in fields from the message, and reconstructing the object, and load of this processing tends to increase. Thus, even when a communication interface having a high maximum speed is used, the object assembly performed by the software becomes a bottleneck and thus the transmission rate of objects may not improve.

Meanwhile, some communication interfaces have hardware that couples data in non-contiguous storage areas in a memory to generate and transmit a message and divides a received message and writes the resulting data to non-contiguous storage areas in the memory. Such hardware processing may be called “scatter-gather direct memory access (DMA)”. Typically, objects of types having different structures are transmitted between computers. Thus, it is difficult for communication interfaces to determine, in a uniform manner, how to divide a received message and how to write the resulting data to a memory, and it is therefore difficult to utilize hardware processing of the communication interfaces.

### SUMMARY

According to an aspect of the invention, a non-transitory computer-readable storage medium storing a program causing a computer that communicates with another computer to execute a process, the process includes establishing connections corresponding to types of object with the other computer, each type of object including two or more data items; selecting, from the connections, a first connection corresponding to a type of an object to be transmitted; and transmitting the object to the other computer through the first connection.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an information processing system according to a first embodiment;

FIG. 2 illustrates an information processing system according to a second embodiment;

FIG. 3 is a block diagram illustrating a hardware example of a server apparatus;

FIG. 4 is a block diagram illustrating a functional example of the server apparatus;

FIG. 5 illustrates an example in which messages are generated from objects;

FIG. 6 is an example in which each message is divided and resulting data are stored in buffers;

FIG. 7 illustrates an example of a connection table and a credit table;

FIG. 8 illustrates an example of scatter lists;

FIG. 9 is a flowchart illustrating a procedure example of object transmission control;

FIG. 10 is a flowchart illustrating a procedure example of object reception control;

FIG. 11 is a flowchart illustrating a procedure example of other object transmission control; and

FIG. 12 is a flowchart illustrating a procedure example of other object reception control.

### DESCRIPTION OF EMBODIMENTS

Embodiments will be described below with reference to the accompanying drawings.

### First Embodiment

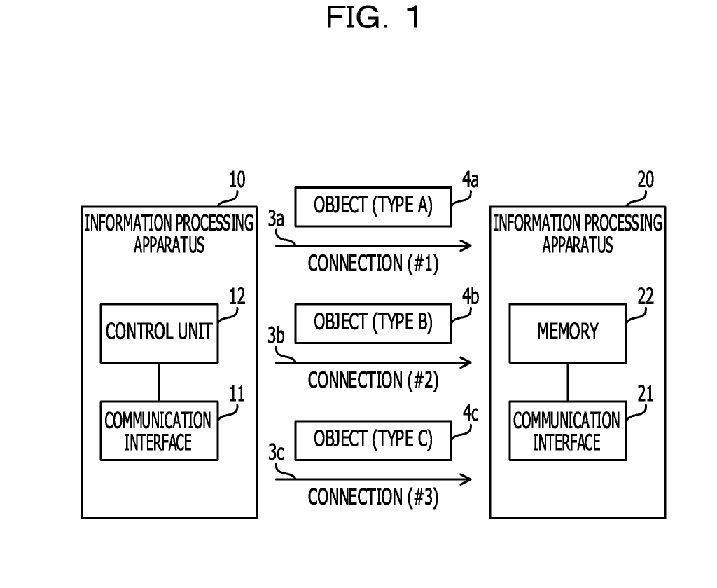

FIG. 1 illustrates an information processing system according to a first embodiment. The information processing system according to the first embodiment includes information processing apparatuses 10 and 20. Each of the information processing apparatuses 10 and 20 may be a server computer or a client computer operated by a user. The information processing apparatuses 10 and 20 communicate with each other through a network.

Each of the information processing apparatuses 10 and 20 executes a program that deals with objects. Source code of the program is written, for example, in an object-oriented language. Each object may have a structure corresponding to a type (for example, a class) defined by the program and may include two or more data items. Types (for example, integer types or floating point types) of the two or more data items may be different from each other. The objects are not limited to specific objects handled by the object-oriented program and may be structure data. In the first embodiment, the information processing apparatus 10 is assumed to transmit objects to the information processing apparatus 20.

The information processing apparatus 10 has a communication interface 11 and a control unit 12. The communication interface 11 is an interface for connecting to the network in a wired or wireless manner, and is, for example, a network interface card (NIC). The control unit 12 may include a processor. The processor is, for example, a central processing unit (CPU) or a digital signal processor (DSP). The processor may include circuits, such as an application specific integrated circuit (ASIC) or a field programmable gate array (FPGA) circuit. The processor may be implemented by a collection of processors (that is, a multiprocessor). The processor executes, for example, a program stored in a memory, such as a random access memory (RAM).

The communication interface 11 establishes connections corresponding to types of object with the information processing apparatus 20. Examples of the connections include a Transmission Control Protocol (TCP) connection or an InfiniBand reliable connection (RC). In the example in FIG. 1, the communication interface 11 establishes a connection 3a corresponding to type A, a connection 3b corresponding to type B, and a connection 3c corresponding to type C with the information processing apparatus 20. Dedicated connections may be provided for some of types of object transmittable from the information processing apparatus 10 to the information processing apparatus 20. In such a case, it is preferable to prepare dedicated connections corresponding to, among the types of transmittable object, types of object having relatively high transmission frequencies.

The control unit 12 transmits objects via the communication interface 11. When the type of an object to be transmitted is a type for which a dedicated connection is prepared, the control unit 12 selects the connection corresponding to the type of the object from established connections. The control unit 12 controls the communication interface 11 so as to transmit an object through the selected connection. For example, an object 4a of type A is transmitted through the connection 3a. An object 4b of type B is transmitted through the connection 3b. An object 4c of type C is transmitted through the connection 3c.

It is preferable that any object of a type other than type A not be transmitted through the connection 3a, any object of a type other than type B not be transmitted through the connection 3b, and any object of a type other than type C not be transmitted through the connection 3c. When no dedicated connection is prepared for the type of an object to be transmitted, the control unit 12 controls, for example, the communication interface 11 so as to transmit the object by using a connection other than the connections 3a, 3b, and 3c. Any non-dedicated connection not associated with a specific type of object may be pre-established by the communication interface 11 or may be dynamically established during transmission.

When an object is transmitted, the object is converted into a message in a format corresponding to the type of the object. For example, two or more data items included in the object are arranged in an order corresponding to the type of the object. When a plurality of dedicated connections are established, the format of the message to be transmitted may vary depending on the individual connection. The object format may be converted (serialized) as software processing by the control unit 12 or may be converted as hardware processing by the communication interface 11. The latter hardware processing is realized, for example, by using a scatter-gather DMA function included in the communication interface 11. In this case, for example, positions in a memory where data items are stored are reported from the control unit 12 to the communication interface 11.

The information processing apparatus 20 includes a communication interface 21 and a memory 22. The communication interface 21 connects to the network in a wired or wireless manner, similarly to the communication interface 11. The communication interface 21 is, for example, a NIC. The memory 22 is a storage device, such as a RAM, for storing data processed according to a program.

The communication interface 21 establishes connections corresponding to types of object with the information processing apparatus 10. Upon receiving a message from the information processing apparatus 10, the communication interface 21 identifies a connection through which the message was received. When the identified connection is a dedicated connection corresponding to any of the types of object, the communication interface 21 extracts data items in an object from the message by using a method corresponding to the identified connection and writes the data items to the memory 22. The number of data items extracted by the communication interface 21 may be two or more. Two or more data items may be written to non-contiguous storage areas in the memory 22.

Hardware processing of the communication interface 21 may be realized, for example, using a scatter-gather DMA function included in the communication interface 21. For example, pieces of format information, each indicating a message format and positions in the memory 22 to which data items to be extracted are to be written, are set in the communication interface 21 for the respective dedicated connections. Based on the piece of format information corresponding to the connection through which the message was received, the communication interface 21 extracts data items from the message and writes the data items to the memory 22. Use of the hardware processing of the communication interface 21 allows for omission of software processing to construct (deserialize) an object.

For example, format information that indicates the order of two or more data items included in an object of type A, the lengths of the data items, and positions in the memory 22 to which the data items are to be written is set in the communication interface 21 in association with the connection 3a. Similarly, format information for type B is set in the communication interface 21 in association with the connection 3b. Format information for type C is also set in the communication interface 21 in association with the connection 3c. Even when the structures of objects (that is, the structures of messages) are different between types A, B, and C, the communication interface 21 can appropriately process a message by referring to the format information corresponding to the connection through which the message was received.

When the connection through which the message was received is not a dedicated connection corresponding to a specific type of object, for example, the communication interface 21 directly writes the received message to the memory 22 as a stream. The message is then analyzed through deserialization in the software processing, data items are extracted from the message, and an object is reconstructed. During the period between reception of the message and reconstruction of the object, the message and the data items are copied in the memory 22 multiple number of times.

In the information processing system according to the first embodiment, connections corresponding to types of object are established between the information processing apparatuses 10 and 20. The connections are then selectively used in accordance with the type of an object to be transmitted. Thus, processing a message by a method corresponding to the connection through which the message was received allows the communication interface 21 in the information processing apparatus 20 to appropriately extract data items in an object from the message and to write the extracted data items to the memory 22. This allows for utilization of the hardware processing of the communication interface 21, thereby making it possible to reduce the load of the software processing in the information processing apparatus 20 and to enhance the efficiency in transmission of objects between the information processing apparatuses 10 and 20.

### Second Embodiment

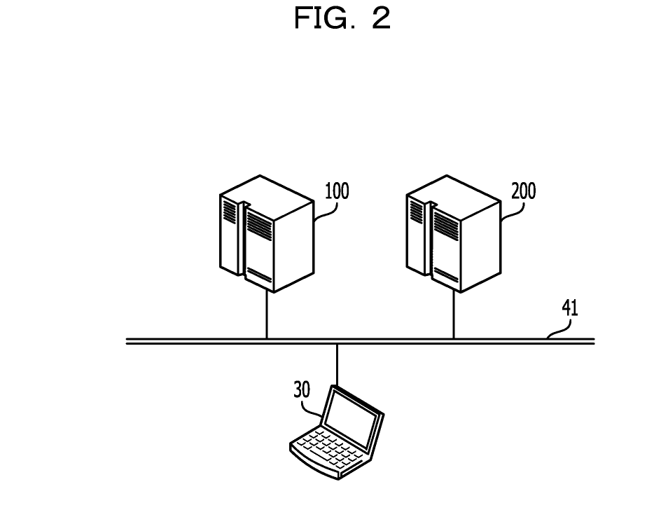

FIG. 2 illustrates an information processing system according to a second embodiment. The information processing system according to the second embodiment includes a client apparatus 30, a network 41, and server apparatuses 100 and 200. The client apparatus 30 and the server apparatuses 100 and 200 are coupled to the network 41. The network 41 is, for example, a local area network (LAN).

The client apparatus 30 is a computer that serves as a terminal apparatus operated by a user. In response to a user operation, the client apparatus 30 causes the server apparatuses 100 and 200 to execute desired information processing. For example, the client apparatus 30 transmits, to the server apparatuses 100 and 200, a command for starting execution of an application program and a command for stopping the application program.

The server apparatuses 100 and 200 are server computers that execute application programs created using an object-oriented language. An OS is running on each of the server apparatuses 100 and 200, and middleware, such as a library or framework, that serves as a platform for executing the application programs is running on the OS. The server apparatuses 100 and 200 may execute the application programs in parallel, and correspondingly, objects may be transmitted between the server apparatuses 100 and 200. A detailed procedure of the object transmission is controlled by the middleware or the OS.

In the second embodiment, a case in which objects are transmitted from the server apparatus 100 to the server apparatus 200 will be mainly discussed. The server apparatus 100 is an example of the information processing apparatus 10 according to the first embodiment, and the server apparatus 200 is an example of the information processing apparatus 20 according to the first embodiment.

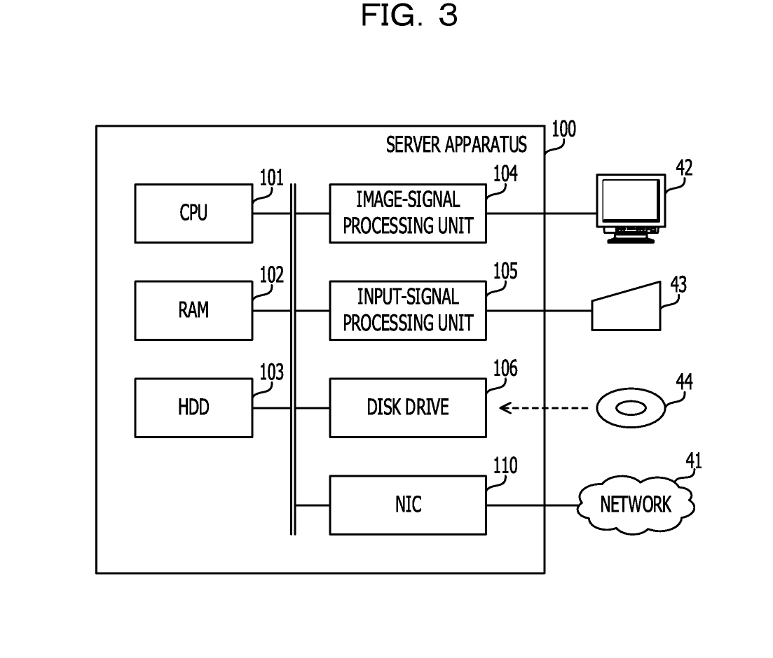

FIG. 3 is a block diagram illustrating a hardware example of a server apparatus. The server apparatus 100 includes a CPU 101, a RAM 102, a hard disk drive (HDD) 103, an image-signal processing unit 104, an input-signal processing unit 105, a disk drive 106, and a NIC 110.

The CPU 101 is a processor that executes instructions for a program. The CPU 101 loads at least part of a program and data, stored in the HDD 103, into the RAM 102 to execute the program. The CPU 101 may also have a plurality of processor cores. The server apparatus 100 may also have a plurality of processors. A plurality of processors or a plurality of processor cores may be used to perform processes (described below) in parallel. A collection of processors (that is, a multiprocessor) may be referred to as a “processor”.

The RAM 102 is a volatile memory that temporarily stores therein the program executed by the CPU 101 and data used for information processing. The server apparatus 100 may have a type of memory other than the RAM. The server apparatus 100 may have a plurality of types of memory.

The HDD 103 is a nonvolatile storage device that stores therein the OS, middleware, and a software program, such as application software, as well as data. The server apparatus 100 may have another type of nonvolatile storage device, such as a flash memory or solid-state drive (SSD). The server apparatus 100 may have a plurality of types of nonvolatile storage device.

In accordance with an instruction from the CPU 101, the image-signal processing unit 104 outputs an image on a display 42 coupled to the server apparatus 100. The display 42 may be implemented by any of various types of display, such as a cathode ray tube (CRT) display, a liquid-crystal display (LCD), a plasma display panel (PDP), and an organic electro-luminescence display (OELD).

The input-signal processing unit 105 obtains an input signal from an input device 43 coupled to the server apparatus 100 and sends the input signal to the CPU 101. The input device 43 may be implemented by any of various types of input device including pointing devices, such as a mouse, a touch panel, a touch pad, and a trackball, as a well as a keyboard, a remote controller, and a button switch. A plurality of types of input device may be coupled to the server apparatus 100.

The disk drive 106 is a drive device that reads a program and data recorded on a recording medium 44. The recording medium 44 is, for example, a magnetic disk, such as a flexible disk (FD) or a HDD; an optical disk, such as a compact disc (CD) or a digital versatile disc (DVD); or a magneto-optical (MO) disk. For example, in accordance with an instruction from the CPU 101, the disk drive 106 stores the program or data, read from the recording medium 44, in the RAM 102 or the HDD 103.

The NIC 110 is a communication interface for communicating with the client apparatus 30 or the server apparatus 200 through the network 41. The NIC 110 may also be a wired interface that is coupled to a cable or a wireless interface that connects to an access point.

The server apparatus 100 may or may not have the disk drive 106. The server apparatus 100, when mainly accessed from a terminal apparatus such as the client apparatus 30, may or may not have the image-signal processing unit 104 and the input-signal processing unit 105. The display 42 and the input device 43 may be integrally formed with the housing of the server apparatus 100. The client apparatus 30 or the server apparatus 200 may also be realized with hardware that is the same as or similar to that of the server apparatus 100.

The NIC 110 is an example of the communication interface 11 in the first embodiment. The CPU 101 is an example of the control unit 12 in the first embodiment. A NIC included in the server apparatus 200 is an example of the communication interface 21 in the first embodiment. A RAM included in the server apparatus 200 is an example of the memory 22 in the first embodiment.

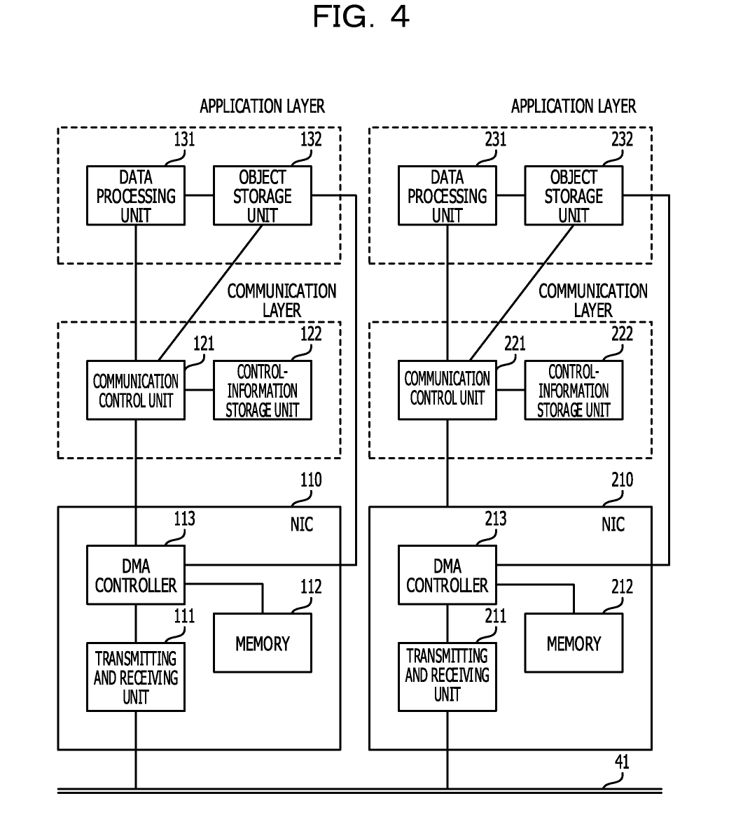

FIG. 4 is a block diagram illustrating a functional example of the server apparatus.

The server apparatus 100 includes the NIC 110, as described above. The server apparatus 100 includes a communication control unit 121, a control-information storage unit 122, a data processing unit 131, and an object storage unit 132. The communication control unit 121 and the data processing unit 131 are realized as, for example, software modules. The control-information storage unit 122 and the object storage unit 132 are realized as, for example, storage areas reserved in the RAM 102.

The NIC 110 includes a transmitting and receiving unit 111, a memory 112, and a DMA controller 113. The aforementioned units in the NIC 110 may be realized as hardware.

The transmitting and receiving unit 111 transmits a message to the server apparatus 200 through the network 41 and receives a message from the server apparatus 200 through the network 41. For transmitting a message, the transmitting and receiving unit 111 establishes a connection with the server apparatus 200 in accordance with an instruction from the communication control unit 121. The connection is a logical communication channel established on the network 41. The connection is, for example, a TCP connection or an InfiniBand RC. The transmitting and receiving unit 111 may establish a plurality of connections with the server apparatus 200. The plurality of connections are identified with connection numbers, such as TCP port numbers. A connection used for transmitting a message is specified by the communication control unit 121.

The memory 112 is a volatile memory, such as a RAM. The memory 112 stores therein gather lists received from the communication control unit 121. The memory 112 may also be a nonvolatile memory. Each gather list indicates fields to be included in a message to be transmitted and also indicates, in the message, an order of the fields. Each gather list includes information regarding positions in the object storage unit 132 where data in the fields are stored and the lengths of the fields.

In accordance with an instruction from the communication control unit 121, the DMA controller 113 causes the transmitting and receiving unit 111 to transmit a message. The DMA controller 113 processes a message received from the transmitting and receiving unit 111. When a message that has a stream format and that is to be output to the network 41 is received from the communication control unit 121, the DMA controller 113 causes the transmitting and receiving unit 111 to transmit the message. On the other hand, when a message send request specifying a gather list is received from the communication control unit 121, the DMA controller 113 directly accesses the object storage unit 132 through hardware processing. In accordance with the gather list, the DMA controller 113 obtains data in fields, assembles a message, and causes the transmitting and receiving unit 111 to transmit the message.

The communication control unit 121 controls communication using the NIC 110. The communication control unit 121 may be implemented as, for example, a communication module in a library for executing an object-oriented program. In such a case, the communication control unit 121 accesses the NIC 110 via the OS by calling an application programming interface (API) of the OS.

Before the server apparatus 100 starts transmitting objects to the server apparatus 200, the communication control unit 121 causes the NIC 110 to establish dedicated connections for respective two or more types of object (for example, classes) among types of transmittable object. Upon receiving an object send request from the data processing unit 131, the communication control unit 121 determines whether or not the type of the object to be transmitted is a type for which a dedicated connection is prepared. When the type of the object is not a type for which a dedicated connection is prepared, the communication control unit 121 obtains data in fields from the object storage unit 132, generates a message, and passes the message to the NIC 110 via the OS. On the other hand, when the type of the object is a type for which a dedicated connection is prepared, the communication control unit 121 causes the NIC 110 to assemble a message by using the DMA function of the NIC 110. That is, the communication control unit 121 generates a gather list instead of a message and passes the gather list to the NIC 110 to thereby cause the NIC 110 to assemble the message.

The control-information storage unit 122 stores therein control information that the communication control unit 121 refers to in order to control object transmission. The control-information storage unit 122 is, for example, a storage area used by a library for executing an object-oriented program. The control information includes connection information and credit information. The connection information indicates a relationship between the types of object and connections, and the credit information indicates “available statutes of buffers in the server apparatus 200 that receives an object.

The data processing unit 131 generates an object in the object storage unit 132 and performs data processing. The data processing unit 131 is implemented as, for example, an application program executed in accordance with an instruction from the client apparatus 30. For transmitting an object to the server apparatus 200, the data processing unit 131 requests the communication control unit 121 to transmit the object. For transmitting an object, the data processing unit 131 may insert a parameter temporarily used for transmission control into the object as a field.

The object storage unit 132 stores therein objects having structures corresponding to types of object (for example, classes) defined by the object-oriented program. The object storage unit 132 is, for example, a user storage area used by an application program. There are cases in which data in fields included in one object are stored in non-contiguous storage areas in the object storage unit 132 in a distributed manner.

The communication control unit 121 and the control-information storage unit 122 belong to a communication layer that provides an application program with a communication function. The data processing unit 131 and the object storage unit 132 belong to an application layer.

Although the above description has been given of a case in which the NIC 110 includes one DMA controller 113, the NIC 110 may have a plurality of DMA controllers. One DMA controller may be responsible for two or more connections or two or more gather lists. Alternatively, one DMA controller may be responsible for only one connection or one gather list. In the former case, for example, each DMA controller may select the gather list used, each time a message is transmitted. In the latter case, for example, when a gather list used is pre-specified in accordance with an instruction from the communication control unit 121, each DMA controller is allowed not to select the gather list each time a message is transmitted.

The server apparatus 200 includes a NIC 210. The server apparatus 200 further includes a communication control unit 221, a control-information storage unit 222, a data processing unit 231, and an object storage unit 232. The communication control unit 221 and the data processing unit 231 are implemented as, for example, software modules. The control-information storage unit 222 and the object storage unit 232 are implemented as, for example, storage areas reserved in a RAM. The units in the server apparatus 200 correspond to the NIC 110, the communication control unit 121, the control-information storage unit 122, the data processing unit 131, and the object storage unit 132 in the server apparatus 100.

The NIC 210 includes a transmitting and receiving unit 211, a memory 212, and a DMA controller 213. The aforementioned units in the NIC 210 may be realized as hardware and correspond to the transmitting and receiving unit 111, the memory 112, and the DMA controller 113 in the NIC 110.

The transmitting and receiving unit 211 receives a message from the server apparatus 100 through the network 41. The transmitting and receiving unit 211 transmits a message to the server apparatus 100 through the network 41.

The memory 212 is a volatile memory, such as a RAM, and stores therein scatter lists, received from the communication control unit 221, in association with connections. The memory 212, however, may also be a nonvolatile memory. The scatter list indicates fields included in a message received through a connection and also indicates, in the message, an order of the fields. The scatter list includes information regarding positions in the object storage unit 232 to which data in the fields are to be written and the lengths of the fields. Buffers for a plurality of messages are prepared for each of the above-described dedicated connections. Thus, a plurality of scatter lists pointing to different positions in the object storage unit 232 are prepared.

The DMA controller 213 processes a message received by the transmitting and receiving unit 211. The DMA controller 213 causes the transmitting and receiving unit 211 to transmit a message in accordance with an instruction from the communication control unit 221. When the transmitting and receiving unit 211 receives a message, the DMA controller 213 attempts to obtain, from the memory 212, scatter lists corresponding to the connection through which the message was received. When there is no scatter lists, the DMA controller 213 passes the received message to the communication control unit 221. On the other hand, when there are scatter lists, the DMA controller 213 extracts data in fields from the message through hardware processing and directly writes the extracted data to the object storage unit 232.

The communication control unit 221 controls communication using the NIC 210. The communication control unit 221 may be implemented as, for example, a communication module in a library for executing the object-oriented program. Upon receiving a message in a stream format from the NIC 210 via the OS, the communication control unit 221 extracts data in fields from the message and reproduces an object in the object storage unit 232. On the other hand, when a notification indicating that a message has been processed by the DMA function is received from the NIC 210, the communication control unit 221 reports, to the data processing unit 231, buffers in the object storage unit 232 in which data are written.

The control-information storage unit 222 stores therein control information that the communication control unit 221 refers to in order to control object reception. The control-information storage unit 222 is, for example, a storage area used by a library for executing the object-oriented program. The control information includes connection information and scatter lists. The connection information indicates a relationship between the types of object and connections, and the scatter lists corresponds to the types of object and are to be set in the NIC 210.

When data in an object received from the server apparatus 100 are written to the object storage unit 232, the data processing unit 231 processes the data. Part of the data written to the object storage unit 232 has parameters temporarily used for receiving the object from the server apparatus 100. When data written to a buffer is not used any more, the data processing unit 231 notifies the communication control unit 221 of the available buffer.

The object storage unit 232 stores therein objects having structures corresponding to types of object (for example, classes) defined in the object-oriented program. The object storage unit 232 includes a table in which buffers in which data in fields included in objects are temporarily stored are listed in association with types of object for which dedicated connections are prepared. When the buffers included in the table are re-used, it is possible to omit dynamic reservation of a storage area for an object each time a message is received. This reduces the amount of load of processing (garbage collection) for automatically releasing a storage area that is not used.

The communication control unit 221 and the control-information storage unit 222 belong to a communication layer that provides an application program with a communication function. The data processing unit 231 and the object storage unit 232 belong to an application layer.

Although a case in which the NIC 210 includes one DMA controller 213 has been described above, the NIC 210 may also include a plurality of DMA controllers. One DMA controller may be responsible for two or more connections or two or more scatter lists. One DMA controller may be responsible for only one connection or one scatter list. In the former case, for example, each time a message is received, each DMA controller may select scatter list used. In the latter case, for example, when scatter lists used are pre-identified in accordance with an instruction from the communication control unit 221, each DMA controller is allowed not to select the scatter list each time a message is received.

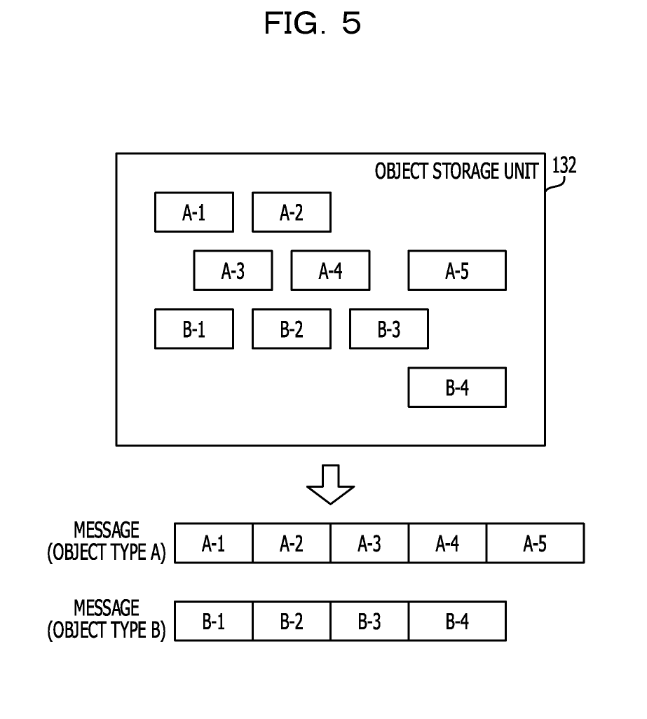

FIG. 5 illustrates an example in which messages are generated from objects. Type A of object including five fields (fields A-1 to A-5) and type B of object including four fields (fields B-1 to B-4) are defined in this case.

Data in the fields A-1 to A-5 included in the object of type A may be stored in non-contiguous storage areas in the object storage unit 132 in the server apparatus 100 in a distributed manner. When the server apparatus 100 transmits the object of type A to the server apparatus 200, the data in the fields A-1 to A-5 distributed in the object storage unit 132 are coupled together in a predetermined order, so that a message corresponding to type A is generated. For example, the data are arranged in an order of the fields A-1, A-2, A-3, A-4, and A-5.

Similarly, data in the fields B-1 to B-4 included in the object of type B may be stored in non-contiguous storage areas in the object storage unit 132 in the server apparatus 100 in a distributed manner. When the server apparatus 100 transmits the object of type B to the server apparatus 200, the data in the fields B-1 to B-4 distributed in the object storage unit 132 are coupled together in a predetermined order, so that a message corresponding to type B is generated. For example, the data are arranged in an order of the fields B-1, B-2, B-3, and B-4.

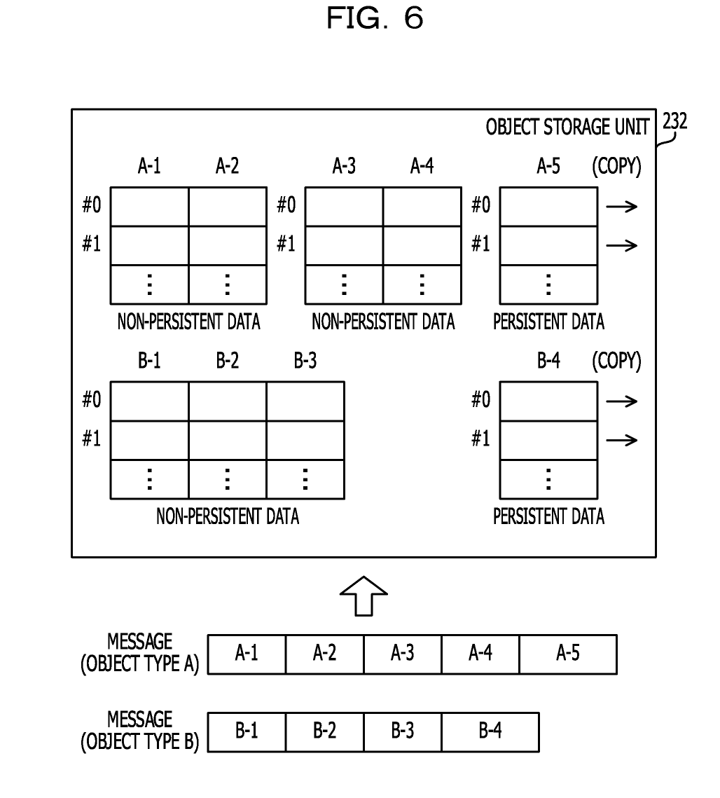

FIG. 6 is an example in which each message is divided and resulting data are stored in buffers.

As described above, a table listing a plurality of buffers is stored in the object storage unit 232 in the server apparatus 200 for each type of object for which a dedicated connection is prepared. The number of buffers per type of object may be pre-determined according to an estimated amount of communication between the server apparatuses 100 and 200. For example, the number of buffers is set to a few tens to several hundreds. The table corresponding to one type of object may be divided into a plurality of parts in accordance with the fields and be stored in non-contiguous storage areas in a distributed manner.

For example, in the example in FIG. 6, a table containing data in the fields A-1 and A-2 for type A, a table containing data in the fields A-3 and A-4 for type A, and a table containing data in the field A-5 for type A are provided in the object storage unit 232. A table containing data in the fields B-1, B-2, and B-3 for type B and a table containing data in the field B-4 for type B are provided in the object storage unit 232.

Upon receiving a message through a dedicated connection, the NIC 210 writes data, extracted from the message, to positions (in columns) corresponding to respective fields in an available buffer of buffers (rows) included in the table. For example, the data in the fields A-1 to A-5 are extracted from the message received through the connection corresponding to type A. The extracted data are then written to positions corresponding to fields in any (for example, buffer #1) of the buffers in the table corresponding to type A. Similarly, data in the fields B-1 to B-4 are extracted from the message received through a connection corresponding to type B. The extracted data are then written to positions corresponding to the fields in any (for example, buffer #0) of the buffers in the table corresponding to type B.

In this case, data in fields include non-persistent data that serve as parameters temporarily used for object transmission and persistent data used continuously for data processing even after the object transmission is completed. In the example in FIG. 6, the fields A-1 to A-4 for type A are fields where non-persistent data are set. The field A5 is a field where persistent data are set. The fields B-1 to B-3 for type B are fields where non-persistent data are set. The field B4 is a field where persistent data are set.

In the second embodiment, after persistent data are temporarily written to buffers in the table, the persistent data are copied to a storage area dynamically reserved in the object storage unit 232. The persistent-data copying is executed as, for example, software processing by the communication control unit 221 (or the data processing unit 231). However, the NIC 210 may directly write the persistent data to a storage area dynamically reserved for each message, rather than writing the persistent data to the buffers in the table. With this arrangement, it is possible to suppress persistent-data copying performed by the software processing.

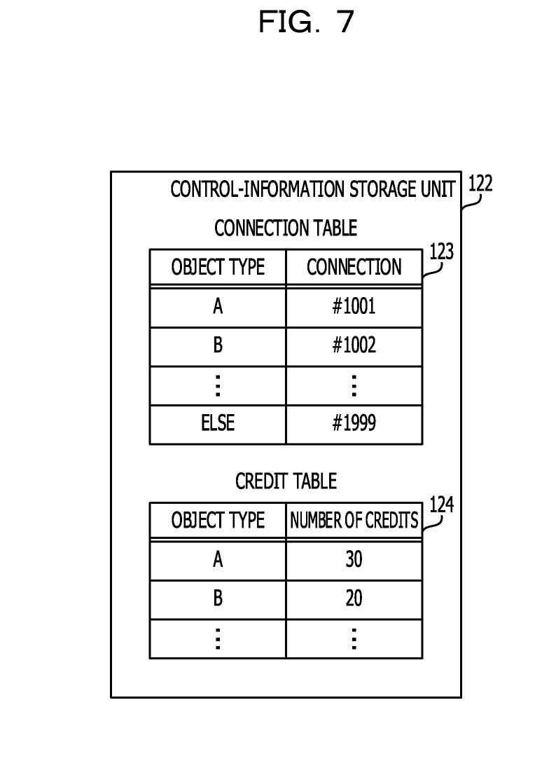

FIG. 7 illustrates an example of a connection table and a credit table. A connection table 123 and a credit table 124 are stored in the control-information storage unit 122 in the server apparatus 100. A connection table that is analogous to the connection table 123 is stored in the control-information storage unit 222 in the server apparatus 200.

The connection table 123 includes “object type” fields and “connection” fields. In each “object type” field, the name of a type of object is registered. In each “connection” field, the identification number of a connection corresponding to the type of object (for example, a TCP port number or an InfiniBand RC number) is registered. An object of a type for which a dedicated connection is not prepared may be transmitted through a pre-established default connection or may be transmitted through a connection dynamically established during transmission. In the former case, for example, the identification number of the default connection is pre-registered in the connection table 123.

The credit table 124 includes “object type” fields and “number of credit” fields. In each “object type” field, the name of the type of object for which a dedicated connection is prepared is registered. In each “number of credit” field, the remaining number of rights (credits) that permit the server apparatus 100 to transmit objects to the server apparatus 200 is registered. It is preferable that an initial value of the number of credits be equal to the number of buffers prepared in the object storage unit 232 in association with the types of object. The server apparatus 100 transmits an object to the server apparatus 200, consuming a credit (that is, reducing the number of credits). When an available buffer is created in the server apparatus 200, the server apparatus 100 is given one credit (that is, the number of credits increases). That is, the states of available buffers are managed using the credits.

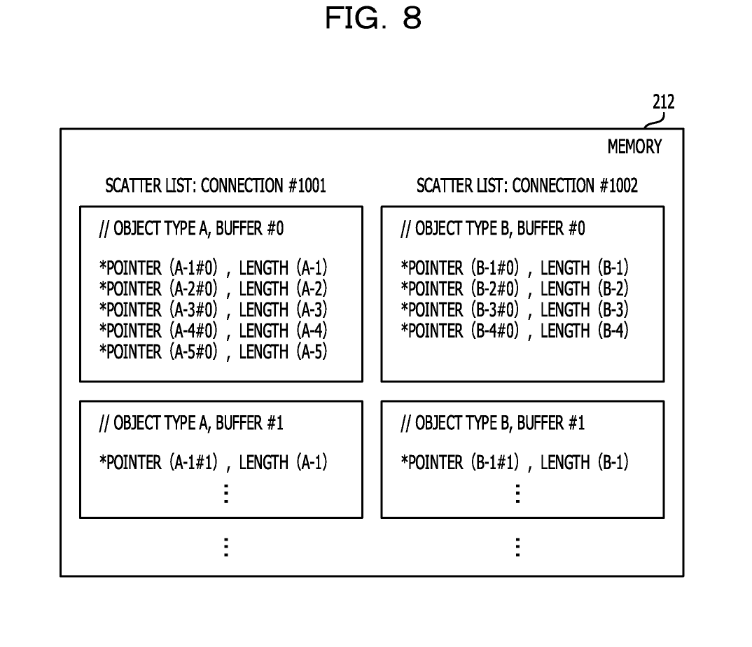

FIG. 8 illustrates an example of the scatter lists. The communication control unit 221 registers, in the memory 212 in the NIC 210 included in the server apparatus 200, scatter lists for each dedicated connection corresponding to a specific type of object.

In each scatter list, pairs of pointers and data lengths of respective fields are listed so that these fields match the order thereof included in a corresponding message. Each pointer is a physical address that points to, in the object storage unit 232, a starting position in a storage area to which data are to be written. One scatter list is registered for each buffer in the table provided in association with the type of object.

For example, a scatter list corresponding to buffer #0 for type A lists the following five records in order:

(1) A starting position in a storage area to which data in the field A-1 in buffer #0 is to be written and the data length of the field A-1

(2) A starting position in a storage area to which data in the field A-2 in buffer #0 is to be written and the data length of the field A-2

(3) A starting position in a storage area to which data in the field A-3 in buffer #0 is to be written and the data length of the field A-3

(4) A starting position in a storage area to which data in the field A-4 in buffer #0 is to be written and the data length of the field A-4

(5) A starting position in a storage area to which data in the field A-5 in buffer #0 is to be written and the data length of the field A-5

Pointers in a scatter list corresponding to another buffer for type A are different from those for buffer #0.

For example, a scatter list corresponding to buffer #0 for type B lists the following four records in order:

(1) A starting position in a storage area to which data in the field B-1 in buffer #0 is to be written and the data length of the field B-1

(2) A starting position in a storage area to which data in the field B-2 in buffer #0 is to be written and the data length of the field B-2

(3) A starting position in a storage area to which data in the field B-3 in buffer #0 is to be written and the data length of the field B-3

(4) A starting position in a storage area to which data in the field B-4 in buffer #0 is to be written and the data length of the field B-4

Pointers in a scatter list corresponding to another buffer for type B are different from those for buffer #0.

First, a number of scatter lists which corresponds to the number of buffers are passed from the communication control unit 221 to the NIC 210 for each dedicated connection. The NIC 210 manages, for each connection, the scatter lists in order. For example, the scatter lists are managed with a first-in first-out (FIFO) structure. When a message is received through one dedicated connection, the NIC 210 selects the scatter list at the front of the scatter lists corresponding to the connection. The NIC 210 then writes data in the fields to the buffer indicated by the selected scatter list. At this point, the NIC 210 discards the selected scatter list. When an available buffer is created, a scatter list corresponding to the available buffer is passed from the communication control unit 221 to the NIC 210 and is added to the tail of the FIFO structure.

In this manner, the buffers included in the table are re-used. Thus, the storage areas in the table are not released by garbage collection.

The gather list passed from the communication control unit 121 to the NIC 110 during transmission of an object also has a data structure similar to the scatter list. Pointers in the gather list point to storage areas in which data in fields inserted into a message are stored.

An OS API called by the communication control unit 121 is defined, for example, as follows:

int send (int fd, struct buf sbuf);

int msend (int fd, struct buf [ ] gList)

The structure “buf” is a pair of a starting address in a storage area and a data length. The function “send” is a function for transmitting data in one contiguous storage area. The function “send” takes a connection and the structure “buf” as arguments. The function “msend” is a function for coupling data in non-contiguous storage areas and transmitting the coupled data. The function “msend” takes an array of the connection and the structure “buf” as an argument. The array of structure “buf” specified as an argument corresponds to the gather list.

The OS API called by the communication control unit 221 is defined, for example, as follows:

int recv (int fd, struct buf rbuf);

int mrecv (int fd, struct buf[ ] sList)

The function “recv” is a function for giving an instruction so that received data is written to one contiguous storage area. The function “recv” takes a connection and the structure “buf” as arguments. The function “mrecv” is a function for giving an instruction so that the received data is divided and the resulting data are written to non-contiguous storage areas. The function “mrecv” takes the connection and the structure “buf” as arguments. The array of the structure “buf” specified as an argument corresponds to a scatter list.

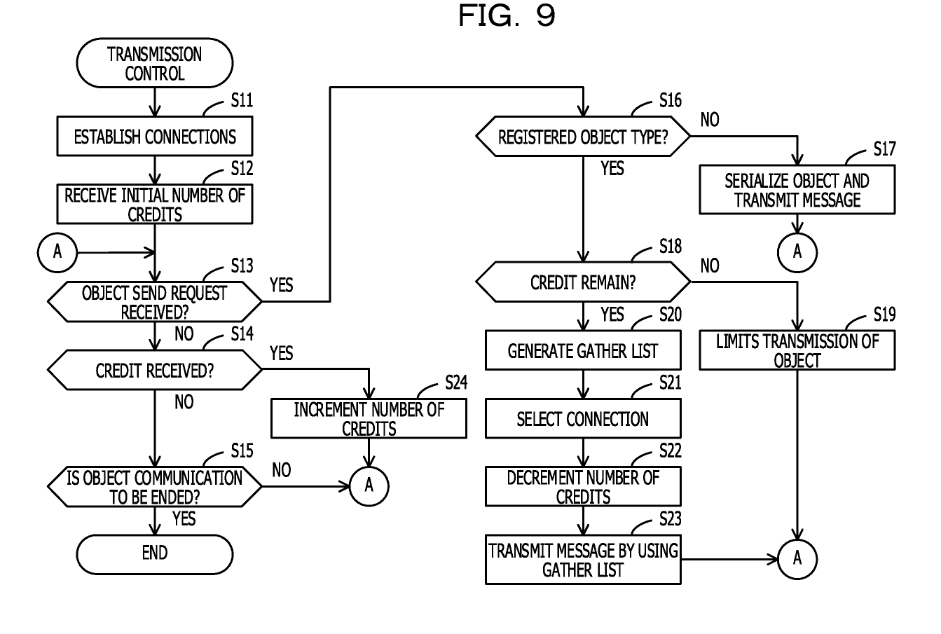

FIG. 9 is a flowchart illustrating a procedure example of object transmission control.

In S11, in accordance with the connection table 123 stored in the control-information storage unit 122, the communication control unit 121 issues, to the NIC 110, an instruction for establishing connections. The transmitting and receiving unit 111 in the NIC 110 establishes a number of connections, the number being indicated by the instruction from the communication control unit 121, with the server apparatus 200. In the second embodiment, the types of object for which dedicated connections are prepared are preset by the user. The identification numbers of the connections corresponding to the respective types of object may be preset by the user or may be automatically selected from available identification numbers. In the latter case, after the connections are established, the communication control unit 121 registers the identification numbers thereof in the connection table 123.

In S12, the communication control unit 121 obtains, from the server apparatus 200 via the NIC 110, a message indicating an initial number of credits for each type of object. The communication control unit 121 registers the numbers of credits in the credit table 124 stored in the control-information storage unit 122.

In S13, the communication control unit 121 determines whether or not an object send request is received from the data processing unit 131. When it is determined that an object send request is received, the process proceeds to S16, and when it is determined that no object send request is received, the process proceeds to S14.

In S14, the communication control unit 121 determines whether or not a message indicating that a credit corresponding to any of the types of object has been given is obtained from the server apparatus 200 via the NIC 110. When a message indicating that a credit corresponding to any of the types of object has been given is obtained, the process proceeds to S24, and when a message indicating that a credit corresponding to any of the types of object has been given is not obtained, the process proceeds to S15.

In S15, the communication control unit 121 determines whether or not the object communication between the server apparatus 100 and the server apparatus 200 is to be ended. A trigger for ending the object communication is, for example, an event in which a command indicating that the application program is to be stopped is entered by a user. When the object communication is not to be ended, the process returns to S13, and when the object communication is to be ended, the object transmission control in FIG. 9 is ended.

In S16, the communication control unit 121 determines whether or not the type of object specified by the data processing unit 131 is a type registered in the connection table 123. When the type of object is registered, the process proceeds to S18, and when the type of object is not registered, the process proceeds to S17.

In S17, the communication control unit 121 serializes the object by software processing. That is, the communication control unit 121 reads data in fields from the object storage unit 132 and couples the data in a predetermined order to thereby generate a message. At this point in time, the serialized message may be temporarily stored in a storage area used by the communication control unit 121 in the RAM 102. The communication control unit 121 then specifies a connection that is not dedicated to a specific type of object (for example, a default connection) and causes the NIC 110 to transmit the created message via the API of the OS. The message may be temporarily copied to, in the RAM 102, a storage area used by the OS. The process then returns to S13.

In S18, the communication control unit 121 obtains, from the credit table 124, the number of credits corresponding to the type of object specified by the data processing unit 131. The communication control unit 121 then determines whether or not any credit for transmitting the object remains, that is, the number of credits is one or more. When any credit remains, the process proceeds to S20. When no credit remains, the process proceeds to S19.

In S19, the communication control unit 121 limits transmission of the object specified by the data processing unit 131. For example, the communication control unit 121 holds transmission of the object until the number of credits reaches one or more. Alternatively, the communication control unit 121 notifies the data processing unit 131 of a transmission failure as a response to the object send request. The process then returns to S13.

In S20, the communication control unit 121 generates a gather list corresponding to the object specified by the data processing unit 131. Physical addresses that point to data in fields included in the specified object are used as pointers in the gather list.

In S21, the communication control unit 121 refers to the connection table 123 to select a connection corresponding to the type of object specified by the data processing unit 131.

In S22, the communication control unit 121 decrements the number of credits for the type of object specified by the data processing unit 131 by “1”, the number of credits being registered in the credit table 124.

The processes in S20 to S22 may be executed in an arbitrary order.

In S23, the communication control unit 121 passes the identification number of the connection selected in S21 and the gather list generated in S20 to the NIC 110 via the OS. In accordance with the gather list, the DMA controller 113 in the NIC 110 obtains the data in the fields from the object storage unit 132 to generate a message. The transmitting and receiving unit 111 in the NIC 110 transmits the generated message to the server apparatus 200 through the connection specified by the communication control unit 121. The process then returns to S13.

In S24, the communication control unit 121 increments the number of credits for the specified type of object by “1”, the number of credits being registered in the credit table 124. The process then returns to S13.

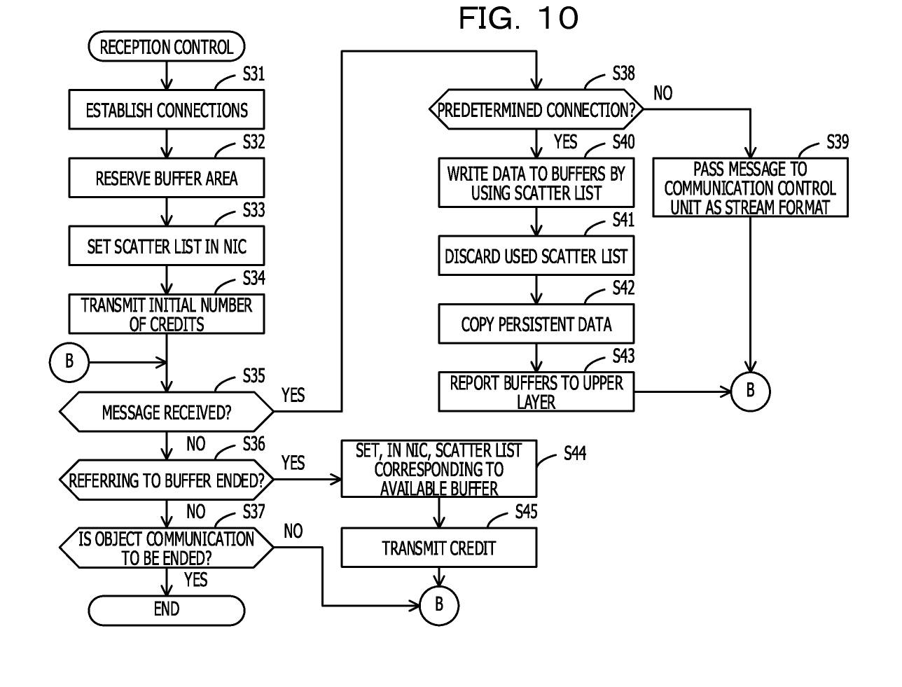

FIG. 10 is a flowchart illustrating a procedure example of object reception control.

In S31, in accordance with a request from the server apparatus 100, the communication control unit 221 controls the NIC 210 so as to establish connections corresponding to respective types of object. Under the control of the communication control unit 221, the transmitting and receiving unit 211 in the NIC 210 establishes the connections with the server apparatus 100. After the connections are established, the communication control unit 221 may also register the identification numbers thereof in the connection table stored in the control-information storage unit 222.

In S32, the communication control unit 221 reserves, in the object storage unit 232, a buffer area having a table structure corresponding to the types of object for which dedicated connections are prepared. A predetermined number of buffers (for example, a few tens to several hundreds of buffers) are prepared for one type of object.

In S33, the communication control unit 221 generates, for each type of object for which the dedicated connection is prepared, scatter lists corresponding to the buffers. Pointers listed in one scatter list point to storage areas in fields in any one of the buffers. The communication control unit 221 then stores the generated scatter lists in the control-information storage unit 222 and also copies the generated scatter lists to the NIC 210. The memory 212 in the NIC 210 stores therein the scatter lists in association with the connections.

In S34, the communication control unit 221 transmits a message indicating an initial number of credits for each type of object to the server apparatus 100 via the NIC 210. It is preferable that the initial number of credits be the same as the number of buffers and the number of scatter lists.

In S35, the DMA controller 213 in the NIC 210 determines whether or not a message about an object is received from the server apparatus 100. When the message is received, the process proceeds to S38. When the message is not received, the process proceeds to S36.

In S36, the communication control unit 221 determines whether or not a notification indicating that data in any of the buffers is not used any more (that is, a buffer becomes available) is received from the data processing unit 231. The notification from the data processing unit 231 includes, for example, the type of object and a buffer number. When the notification is received, the process proceeds to S44. When the notification is not received, the process proceeds to S37.

In S37, the communication control unit 221 determines whether or not the object communication between the server apparatus 100 and the server apparatus 200 is to be ended. A trigger for ending the object communication is, for example, an event in which a command indicating that the application program is to be stopped is entered by the user. When the object communication is not to be ended, the process returns to S35, and when the object communication is to be ended, the object reception control in FIG. 9 is ended.

In S38, the DMA controller 213 determines whether or not the connection through which the message was received is a predetermined connection (a connection dedicated to a specific type of object) with which the scatter lists are associated. When the connection through which the message was received is a predetermined connection, the process proceeds to S40. When the connection through which the message was received is not a predetermined connection, the process proceeds to S39.

In S39, the DMA controller 213 passes the received message to the communication control unit 221 via the OS as a stream format without dividing the message. At this point, the message may be temporarily copied to a storage area used by the OS and a storage area used by the communication control unit 221, the storage areas being included in the RAM 102. The communication control unit 221 deserializes the object by software processing. More specifically, the communication control unit 221 determines the type of the object, based on the contents of the message. The communication control unit 221 then extracts data in fields from the message and reproduces the object in the object storage unit 232. At this point, the object storage unit 232 dynamically reserves a storage area for storing the object. The process then returns to S35.

In S40, the DMA controller 213 obtains, from the memory 212, one scatter list (for example, the scatter list at the front) from the collection of scatter lists corresponding to the connection through which the message was received. By using the obtained scatter list, the DMA controller 213 directly writes the data in the fields included in the message to the object storage unit 232 by hardware processing. That is, the DMA controller 213 divides the message in accordance with data lengths listed in the scatter list. The DMA controller 213 then writes the data in the fields to storage areas pointed to by the pointers listed in the scatter list.

In S41, the DMA controller 213 discards the used scatter list. The DMA controller 213 reports, to the communication control unit 221, information indicating the buffer in which the data were written (for example, a connection number and a scatter list number).

In S42, when the received message includes persistent data, the communication control unit 221 reserves a new storage area in the object storage unit 232. The communication control unit 221 copies the data written in the buffer in the table for persistent data. As described above, however, the NIC 210 may directly write the persistent data to a storage area dynamically reserved, to avoid the data copying. The fields where the persistent data are set are pre-specified by the user.

In S43, the communication control unit 221 reports, to the data processing unit 231, information (for example, the type of object and a buffer number) indicating the buffer in which the data were written. When the received message includes persistent data, the communication control unit 221 reports the dynamically reserved storage areas to the data processing unit 231. The process then returns to S35.

In S44, the communication control unit 221 obtains a scatter list corresponding to the available buffer from the control-information storage unit 222 and refers to the connection table to check a connection corresponding to the type of object. The communication control unit 221 then specifies the connection and passes the scatter list to the NIC 210. The passed scatter list is then added to (for example, the tail of) a collection of scatter lists held in the memory 212, the collection corresponding to the specified connection.

In S45, the communication control unit 221 transmits a message indicating assignment of a credit to the server apparatus 100 via the NIC 210. The process then returns to S35.

When a plurality of objects are transmitted using a plurality of connections, the order of the objects may be reversed on the network 41. That is, a transmission order recognized by the data processing unit 131 and a transmission order recognized by the data processing unit 231 may not match each other. This problem, however, may be overcome by data processing performed by the data processing unit 131 and the data processing unit 231, such as inserting information indicating an order into the objects as a parameter, taking the order reversal into account. This problem may also be overcome by performing object transmission using a dedicated connection by limiting the object transmission to an application program or a type of object whose result of data processing does not depend on the order.

According to the information processing system in the second embodiment, dedicated connections are established between the server apparatuses 100 and 200 with respect to respective types of object. Thus, objects of these types can be periodically processed using the scatter-gather DMA function of the NIC 210. Compared with a case in which all objects are deserialized by software processing, it is possible to reduce the load on the server apparatus 200. It is therefore possible to reduce the possibility that software processing becomes a bottleneck and it is possible to increase the rate of object transmission. In particular, when dedicated connections are prepared for types of object having higher transmission frequencies with higher priority, it is possible to expect a higher rate of object transmission.

The use of the scatter-gather DMA function of the NIC 210 makes it possible to suppress data copying to the RAM in the server apparatus 200. As a result, the load for dynamically reserving or releasing the storage area is reduced. A plurality of buffers in a tabular format are prepared for fields where non-persistent data that are highly likely to be discarded in a short period of time are set. As a result of re-using the buffers, the load of garbage collection is reduced.

### Third Embodiment

A third embodiment will be described next. A difference from the second embodiment described above will mainly be described. Description of points that are the same as or similar to those in the second embodiment is hereinafter omitted as appropriate.

In an information processing system in the third embodiment, object types for which dedicated connections are prepared may be changed depending on the transmission state of objects. The information processing system in the third embodiment may be realized by a system configuration that is the same as or similar to the system configuration illustrated in FIGS. 2 to 8. Thus, the third embodiment is described using the same reference characters in the second embodiment (that is, the reference characters in FIGS. 2 to 8).

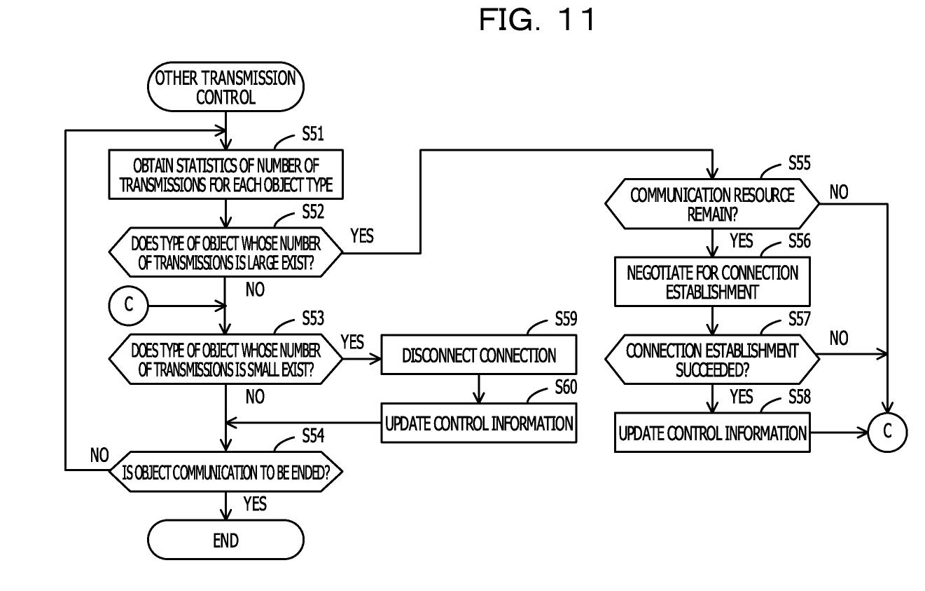

FIG. 11 is a flowchart illustrating a procedure example of other object transmission control. The server apparatus 100 may execute the processing in FIG. 11 in parallel with the processing in FIG. 9.

In S51, the communication control unit 121 monitors the transmission state of objects to obtain statistics of the number of transmissions for each type of object. The number of transmissions is, for example, the number of transmissions in a most recent predetermined period of time or the number of transmissions after process in S52 or S53 described below was executed last time.

In S52, the communication control unit 121 determines whether or not a type of object whose number of transmissions is large exists in the types of object for which no dedicated connections are prepared (that is, in the types that are unregistered in the connection table 123). A criterion for this determination is that, for example, the number of transmissions is larger than or equal to a preset threshold or the ratio of the number of transmissions to the number of transmissions of all objects is larger than or equal to a predetermined threshold. When a type that satisfies the above-described condition exists in unregistered types, the process proceeds to S55. When a type that satisfies the above-described condition does not exist, the process proceeds to S53.

In S53, the communication control unit 121 determines whether or not a type of object whose number of transmissions is small exists in the types of object for which dedicated connections are prepared (that is, in the types that are registered in the connection table 123). A criterion for the determination is that, for example, the number of transmissions is smaller than a preset threshold, the ratio of the number of transmissions to the number of transmissions of all objects is smaller than a predetermined threshold, or a certain amount of time has passed from the time when an object was transmitted last time. When a type that satisfies the above-described condition exists in the registered types, the process proceeds to S59. When a type that satisfies the above-described condition does not exist, the process proceeds to S54.

In S54, the communication control unit 121 determines whether or not the object communication between the server apparatus 100 and the server apparatus 200 is to be ended. When the object communication is not to be ended, the process returns to S51 in which the transmission state of objects is monitored (for example, the number of transmissions is counted in a predetermined period of time). When the object communication is to be ended, the object transmission control illustrated in FIG. 11 is ended.

In S55, the communication control unit 121 determines whether or not a communication resource remains, that is, whether or not the NIC 110 is permitted to add another connection. When a communication resource remains, the process proceeds to S56, and when no communication resource remains, the process proceeds to S53.

In S56, the communication control unit 121 negotiates with the server apparatus 200 to attempt to add a connection corresponding to the type of object whose number of transmissions was determined to be large. That is, the communication control unit 121 transmits a connection establish request to the server apparatus 200 via the NIC 110 and waits for a response from the server apparatus 200. Upon receiving a permission response from the server apparatus 200, the communication control unit 121 instructs the NIC 210 so as to add the connection. The connection establish request specifies a type of object.

In S57, the communication control unit 121 determines whether or not the connection establishment has succeeded as a result of the negotiation in S56. Examples of a case in which the connection establishment fails include a case in which a rejection response is received from the server apparatus 200. When the connection establishment has succeeded, the process proceeds to S58. When the connection establishment has failed, the process proceeds to S53.

In S58, the communication control unit 121 associates and registers the type of object and the identification number of the established connection in the control-information storage unit 122 stored in the connection table 123. The communication control unit 121 obtains a message indicating an initial number of credits from the server apparatus 200. The communication control unit 121 then associates and registers the type of object and the initial number of credits in the credit table 124 stored in the control-information storage unit 122. The process then proceeds to S53.

In S59, the communication control unit 121 cooperates with the server apparatus 200 to disconnect a connection corresponding to the type of object whose number of transmissions was determined to be small. That is, the communication control unit 121 transmits a connection release request to the server apparatus 200 via the NIC 110. Upon receiving a response from the server apparatus 200, the communication control unit 121 requests NIC 210 so as to disconnect the connection. This connection disconnect request specifies the type of object.

In S60, the communication control unit 121 deletes the identification number of the disconnected connection from the connection table 123. The communication control unit 121 deletes, from the credit table 124, the number of credits for the disconnected connection. The process then proceeds to S54.

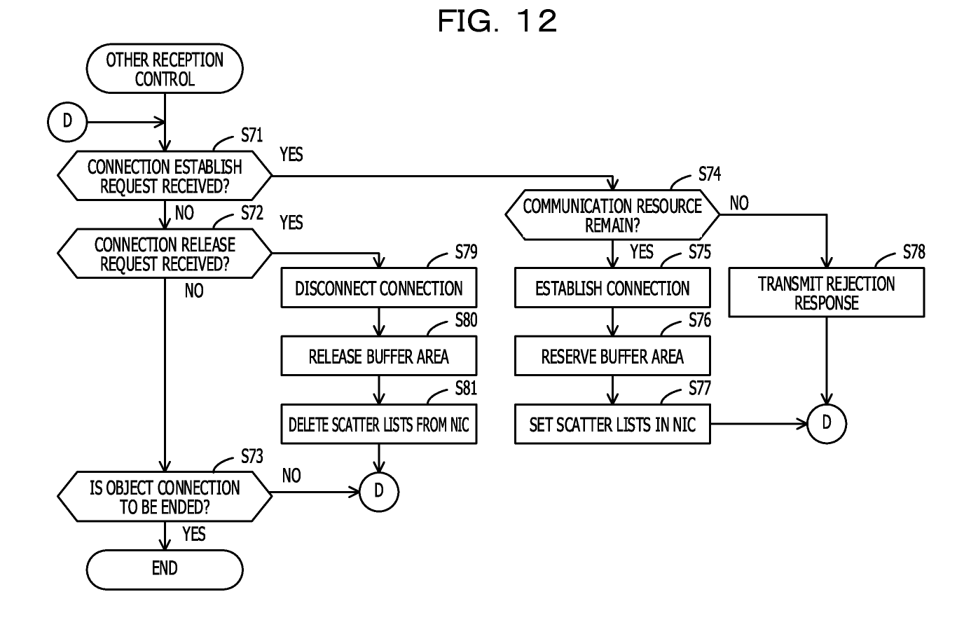

FIG. 12 is a flowchart illustrating a procedure example of other object reception control. The server apparatus 200 may execute the processing illustrated in FIG. 12 in parallel with the processing illustrated in FIG. 10.

In S71, the communication control unit 221 determines whether or not a connection establish request is received from the server apparatus 100 via the NIC 210. When a connection establish request is received, the process proceeds to S74. When no connection establish request is received, the process proceeds to S72.

In S72, the communication control unit 221 determines whether or not a connection release request is received from the server apparatus 100 via the NIC 210. When a connection release request is received, the process proceeds to S79. When no connection release request is received, the process proceeds to S73.

In S73, the communication control unit 221 determines whether or not the object communication between the server apparatus 100 and the server apparatus 200 is to be ended. When the object communication is not to be ended, the process returns to S71. When the object communication is to be ended, the object reception control illustrated in FIG. 12 is ended.

In S74, the communication control unit 221 determines whether or not a communication resource remains, that is, whether or not the NIC 210 is permitted to add another connection. When a communication resource remains, the process proceeds to S75. When no communication resource remains, the process proceeds to S78.

In S75, the communication control unit 221 transmits a permission response message to the server apparatus 100 via the NIC 210. The communication control unit 221 instructs the NIC 210 so as to add a connection. As a result, a new connection is established between the server apparatuses 100 and 200. The communication control unit 221 registers the type of object specified by the connection establish request and the identification number of the connection in a connection table in association with each other.

In S76, the communication control unit 221 reserves, in the object storage unit 232, a buffer area having a table structure corresponding to the type of object specified by the connection establish request. The reserved buffer area includes a predetermined number of buffers (for example, a few tens to several hundreds of buffers). Fields where persistent data are set are pre-specified by the user.

In S77, the communication control unit 221 generates scatter lists corresponding to the buffers. The communication control unit 221 then stores the generated scatter lists in the control-information storage unit 222 and also copies the scatter lists to the NIC 210 in association with the added connection. The communication control unit 221 transmits a message indicating an initial number of credits to the server apparatus 100 via the NIC 210. The process then returns to S71.

In S78, the communication control unit 221 transmits a rejection response message to the server apparatus 100 via the NIC 210. The process then returns to S71.

In S79, the communication control unit 221 refers to the connection table to identify a connection corresponding to the type of object specified by the connection release request. The communication control unit 221 then instructs the NIC 210 so as to disconnect the connection. The communication control unit 221 transmits a response message to the server apparatus 100 via the NIC 210. The communication control unit 221 deletes the identification number of the disconnected connection from the connection table.

In S80, the communication control unit 221 releases, in the object storage unit 232, a buffer area having a table structure corresponding to the type of object specified by the connection release request.

In S81, the communication control unit 221 deletes the scatter lists corresponding to the disconnected connection from the control-information storage unit 222. The communication control unit 221 instructs the NIC 210 via the OS so as to delete the scatter lists from the memory 212 in the NIC 210. The process then proceeds to S71.

The processes in S79, S80, and S81 may be executed in an arbitrary order.

The information processing system in the third embodiment provides advantages that are the same as or similar to those in the second embodiment. In addition, in the third embodiment, when the transmission frequency of one type of object increases, a dedicated connection is automatically assigned to the type of object. When the transmission frequency of one type of object decreases, a dedicated connection assigned to the type of object is automatically released. Thus, even when the transmission frequency of each type of object differs from a pre-estimated transmission frequency, it is possible to flexibly control connections and it is possible to enhance the transmission efficiency.

Although a case in which an object is transmitted from the server apparatus 100 to the server apparatus 200 has been described above in the second and third embodiments, an object may also be transmitted from the server apparatus 200 to the server apparatus 100. In this case, each connection may be used for only a unidirectional communication or may be used for bidirectional communications. In the former case, even when a connection for transmitting an object from the server apparatus 200 to the server apparatus 100 has been established, another connection is established when an object is transmitted from the server apparatus 200 to the server apparatus 100. In the latter case, on the other hand, when a connection for transmitting an object from the server apparatus 100 to the server apparatus 200 has been established, the established connection is used when an object is transmitted from the server apparatus 200 to the server apparatus 100.

In the second and third embodiments described above, a case in which an object is transmitted between two server apparatuses 100 and 200 has been described. However, when an object is transmitted among three or more server apparatuses, a connection may also be established for each pair of two of the server apparatuses. However, the connection establishment and release determination described above in the third embodiment may be intensively performed by a single master server apparatus, rather than being performed by the individual server apparatuses in a distributed manner. In such a case, for example, when the master server apparatus monitors the object transmission state of at least one server apparatus, it is possible to keep track of the tendency of a transmission frequency for each type of object. Although a case in which the server apparatus 100 at the transmitting end determines the establishment and release of a connection has been described in the third embodiment, the server apparatus 200 at the receiving end may determine the establishment and release of a connection.

The software processing in the first embodiment may be executed by causing the information processing apparatus 10 or 20 to execute a program. The software processing in the second and third embodiments may be executed by causing the client apparatus 30 or the server apparatus 100 or 200 to execute a program. The program may be pre-recorded in a computer-readable recording medium (for example, the recording medium 44). Examples of the recording medium include a magnetic disk, an optical disk, a magneto-optical disk, and a semiconductor memory. Examples of the magnetic disk include an FD and a HDD. Examples of the optical disk include a CD, a recordable/rewritable compact disk (CD-R/RW), a DVD, and a DVD-R/RW. The program may be recorded to portable recording media and be distributed. In this case, the program may be duplicated in (installed to) another recording medium (for example, the HDD 103), such as a HDD, from a portable recording medium and be executed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program causing a computer that communicates with another computer to execute a process, the process comprising:
establishing connections corresponding to types of object with the other computer, each type of object including two or more data items;
selecting, from the connections, a first connection corresponding to a type of an object to be transmitted; and
transmitting the object to the other computer through the first connection.

2. The storage medium according to claim 1,
wherein, when the type of the object corresponds to one of the types of object, the first connection is selected from the connections and the object is transmitted to the other computer through the first connection; and
when the type of the object to be transmitted does not correspond to any of the types of object, the object is transmitted through a second connection corresponding to a type of object other than the types of object.

3. The storage medium according to claim 1,
wherein the object is stored in a memory included in the computer, and when the object stored in the memory is transmitted, the object is converted into a format corresponding to the selected first connection.

4. The storage medium according to claim 3,
wherein the converting the object is executed by scatter-gather direct memory access (DMA) processing.

5. The storage medium according to claim 4,
wherein pieces of format information associated with the respective connections are stored in the memory, each piece of format information including a message format and positions in the memory to which data items are to be written;
data items corresponding to the first connection are extracted based on the corresponding piece of format information; and
the object is converted based on the data items corresponding to the first connection.

6. The storage medium according to claim 1,
wherein the process further comprises:
monitoring a state of transmission of an object to the other computer; and
performing, based on the state of transmission, at least one of adding a connection corresponding to a type of object other than the types of object and disconnecting the connection corresponding to one of the types of object.

7. The storage medium according to claim 1,
wherein the connections correspond to, among types of transmittable object, types of object having relatively high transmission frequencies.

8. An information processing apparatus, comprising:
a communication interface configured to establish connections corresponding to types of object with another information processing apparatus, each type of object including two or more data items; and
a processor configured to select, from the connections, a first connection corresponding to a type of an object to be transmitted and to control the communication interface so as to transmit the object to the other information processing apparatus through the first connection.

9. An object transmission method executed by an information processing apparatus, the method comprising:
establishing connections corresponding to types of object between a first information processing apparatus and a second information processing apparatus including a communication interface and a memory, each type of object including two or more data items;
transmitting, when a type of an object to be transmitted corresponds to one of the types of object, the object from the first information processing apparatus to the second information processing apparatus through one of the connections which corresponds to the type of the object; and
receiving the object by the communication interface included in the second information processing apparatus and arranging, in the memory included in the second information processing apparatus, the two or more data items included in the object by a method corresponding to the connection through which the object is received.

10. The object transmission method according to claim 9, further comprising:
setting pieces of format information in the communication interface in association with the respective connections, the pieces of format information indicating formats of objects transmitted through the connections,
wherein the arranging the two or more data items in the memory includes arranging the two or more data items in the memory by using the piece of format information corresponding to the connection through which the object is received by the communication interface.

11. The object transmission method according to claim 9,
wherein a table area is reserved in the memory; and
with respect to at least one of the two or more data items, each time an object is received, no new storage area is reserved in the memory and the table area is re-used.
